(19) United States
(12) Patent Application Publication
(10) Pub. No.: US 2023/0409011 A1
(43) Pub. Date: Dec. 21, 2023

(54) INDUSTRIAL FACILITY MONITORING

(71) Applicant: DMI, LLC, Dubuque, IA (US)

(72) Inventors: Brian Vesperman, Madison, WI (US); Christopher John Kuehl, North Barrington, IL (US); Nathan L. Greiner, Hanover, IL (US); Jane McCleary, Cuba City, WI (US); Jasmine Nobis-Olson, Elizabeth, IL (US); Kevin Leahy, Lemont, IL (US)

(21) Appl. No.: 18/212,142

(22) Filed: Jun. 20, 2023

Related U.S. Application Data
(60) Provisional application No. 63/353,784, filed on Jun. 20, 2022.

(51) Int. Cl. G05B 19/418

(52) U.S. Cl. CPC G05B 19/4185; G05B 19/4189

(57) ABSTRACT

An industrial facility monitoring system may include a matrix of radiofrequency (RF) mesh extenders and a processing unit. Each of the RF mesh extenders is fixed to building structures of a facility and located throughout an interior of the facility. Each of the RF mesh extenders is to receive signals from RF emitters coupled to facility occupants. The processing unit receives signals from the RF mesh extenders and determines coordinates of a facility occupant based upon a triangulation of the signals from the matrix of RF mesh extenders.

### CROSS REFERENCE TO RELATED APPLICATIONS

The present patent application is a nonprovisional patent application claiming priority from U.S. provisional patent application Ser. No. 63/353,784 filed on Jun. 20, 2022 by Vesperman et al. and entitled Industrial Facility Monitoring, the full disclosure of which is hereby incorporated by reference.

### BACKGROUND

Industrial facilities are used to manufacture products and/or store inventory or products awaiting completion or awaiting shipment. Some industrial facilities may be in the form of warehouse storing products received from a manufacturer and awaiting shipment to a purchaser. Such industrial facilities may include a building that contains static occupants such as manufacturing equipment, conveyors, overhead trolleys, material storage bins, tanks and other similar static equipment and occupants. Such industrial facilities may also include dynamic occupants such as inventory, products, transport vehicles, such as forklifts, floor sweepers, and facility personnel. Such dynamic occupants may also move outside the building. Monitoring and managing such a complex industrial ecosystem presents a challenge.

### BRIEF DESCRIPTION OF THE DRAWINGS

FIG. 1 is a diagram schematically illustrating portions of an example industrial facility monitoring system.

FIG. 2 is a flow diagram of an example industrial facility monitoring method.

FIG. 3 is a diagram schematically illustrating portions of an example radiofrequency (RF) mesh extender.

FIG. 4 is a diagram schematically illustrating portions of an example RF mesh extender.

FIG. 5 is a diagram schematically illustrating portions of an example industrial facility monitoring system.

Throughout the drawings, identical reference numbers designate similar, but not necessarily identical, elements. The figures are not necessarily drawn to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example industrial facility monitoring systems that employ a matrix of radiofrequency (RF) mesh devices designed to increase the area of mesh covered within the facility and are affixed to building structures of the facility and located throughout an interior of the building. The RF mesh extenders communicate with one another and form a network of communication nodes to receive signals from RF emitters which are coupled to various occupants of the facility. The systems further include a processing unit that communicate with the RF mesh extenders. The processing unit may determine coordinates of a facility occupant based upon a triangulation of the signals received from the different RF mesh extenders of the matrix. Any data represented by the signals received from the RF emitter associated with the facility occupant may be associated with the determined coordinates.

The associated data and coordinates may facilitate enhanced monitoring and management of the facility. For example, the data may be used as an input to decision model to generate control signals for the facility occupant or other facility occupants or may be used as an input to a decision model to generate a notification, such as a warning, for decision-makers associated with the facility.

In some implementations, the system may include multiple varied RF emitters associated with multiple facility occupants, wherein the different RF emitters transmits signals having different data formats. In such an implementation, the processing unit may translate each of the different signals to determine the associated data with each signal. As result, the processing unit may carry out a form of data unification, wherein the translated uniform data may be more easily used as input to a decision model.

In some implementations, the RF mesh extenders may provide additional functions. For example, the individual RF mesh extenders may include a temperature and/or humidity RF emitter, wherein the data is communicated through the mesh of RF devices to the processing unit for further use as input to a decision model.

In some implementations, the RF mesh extenders are affixed to building structures in the form of light fixtures. In some implementations, the individual RF mesh extenders may include a light controller, a proximity RF emitter and/or light intensity RF emitter. Signals from the proximity RF emitter and/or light intensity RF emitter may be used by the local light controller on the RF mesh extender to control the light fixture. For example, the light fixture may be powered, unpowered or have a light intensity adjustment based upon the sensed proximity of a facility occupant, such as facility personnel. The light fixture may be powered, unpowered or have a light intensity adjustment based upon the sensed ambient lighting conditions as detected by the light intensity RF emitter.

In some implementations, areas external to the building of the facility, such as parking lots, loading/unloading areas and the like may also include a matrix of radiofrequency mesh extenders which are affixed to facility structures, such as light fixtures. Such external RF mesh extenders may cooperate with others to form a network of signal receiving nodes exterior to the facility building. Facility occupants which have moved out of the building and/or facility occupants which occupy areas external to the building may carry RF emitters which transmit signals to the external RF mesh extenders. The external RF mesh extenders may forward such signals directly or indirectly (through other RF mesh extenders) to the processing unit. The processing unit may use triangulation of the signals to determine coordinates of the facility occupant exterior to the facility building. The processing unit may translate such signals to determine data and associate the determined data with the determined coordinates. The determined data and/or determined coordinates may be used as inputs to a decision model which may result in the processing unit outputting control signals for the facility occupant external to the building or for facility occupants inside the building. The processing may further output notifications to those decision-makers associated with the facility.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, the term “coupled” shall mean the joining of two members directly or indirectly to one another. Such joining may be stationary or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means the two structures may be repeatedly connected and disconnected to and from one another without material damage to either of the two structures or their functioning.

For purposes of this disclosure, unless explicitly recited to the contrary, the determination of something “based on” or “based upon” certain information or factors means the determination is made as a result of or using at least such information or factors; it does not necessarily mean the determination is made solely using such information or factors. For purposes of this disclosure, unless explicitly recited to the contrary, an action or response “based on” or “based upon” certain information or factors means the action is in response to or as a result of such information or factors; it does not necessarily mean the action results solely in response to such information or factors.

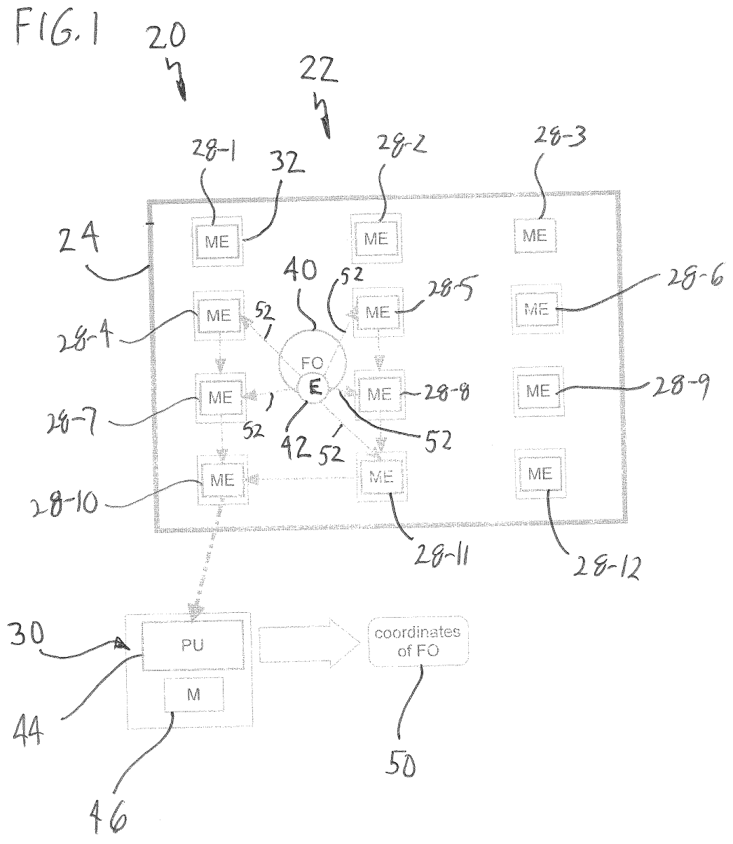

FIG. 1 is a diagram schematically illustrating portions of an example industrial facility monitoring system 20. System 20 is for use in an industrial facility 22 comprising a building 24. System 20 assists in collecting signatures from various RF emitters carried by, connected to or otherwise associated with various occupants of facility 22 (facility occupants FO). System utilizes the collected signals to determine the specific coordinates of such facility occupants. System 20 not only determines the presence of a facility occupant, but the precise location of coordinates of the facility occupant or occupants. By determining the precise location of coordinates of those occupants of facility 22, system 20 facilitates enhanced management of facility 22. System comprises a matrix of radio frequency (RF) mesh extenders (ME) 28-1, 28-2, 28-3, . . . 28-12 (collectively referred to as mesh extenders 28) and 30.

Mesh extenders 28 are fixed to building structures of facility 22. In some implementations, mesh extenders 28 may be directly fixed to structures of the building 24, such as wall or ceiling structures. In some implementations, mesh extenders 28 may be indirectly fixed to building 24, such as by being fixed to fixtures which are mounted to building 24. In the example illustrated, mesh extender 20-3 is directly affixed to building 24, while the remaining mesh extenders 28 are fixed to overhead light fixtures 32. Although system 20 is illustrated as comprising a 3×4 uniform array of mesh extenders 28, in other implementations, the array of mesh extended 28 may be larger or smaller or may not be uniform. For example, portions of building 24 may have a greater density of mesh extenders 28 as compared to other portions of building 24.

Each of mesh extenders 28 communicates with one another and with those RF emitters associated with facility occupants using radiofrequency technology, such as Bluetooth. Each of mesh extenders 28 communicates at least with those surrounding mesh extenders 28. Each of mesh extended 28 may forward signals received two other surrounding mesh extenders. As a result, signals received by one mesh extended 28 may be forwarded across multiple mesh extenders in series or in a chain like fashion to communicate the signal to the final recipient, computing platform 30. In one implementation, mesh extenders 28 are each WIREPAS™ compatible.

FIG. 1 schematically illustrates an example facility occupant 40 within building 24. The facility occupants may take many forms. For example, a facility occupant may comprise a dynamic facility occupant, and occupant that may move about or within the facility, such as facility personnel, inventory, and/or an inventory transport vehicle, such as a forklift or the like, portable manufacturing equipment or a pallet, box, been, portable tank or other portable container for supporting or containing inventory (articles or materials). The faculty occupant may comprise a static occupant, one that is likely to stay put or that is affixed in an established location, such as an inventory transport mechanism, such as a conveyor, overhead cam or the like, a stationary or nonportable bin, tank or the like or static or fixed pieces of manufacturing equipment.

FIG. 1 further schematically illustrates an example RF emitter 42 associated with the facility occupant 40. RF emitter 42 outputs RF signals which are received by those sufficiently proximate matrix extenders 28. In some implementations, the RF signals do not communicate data, but are used by system 20 to determine the current location of the facility occupant 40.

In some implementations, the RF emitter is part of a sensor, wherein the RF signals communicate sensed data or operational data associated with the facility occupant 40. For example, the sensor may be connected to a reel of wire or other material to sense the amount of material wound about the real. The sensor may comprise an optical sensor to detect the amount of liquid or solid material in a tanker bin. The sensor may be configured to check the amount of charge remaining in a battery, such as the battery in a forklift. The sensor may be an optical sensor configured to detect the presence of a pallet and/or detect an amount of inventory on the pallet or on a rack. The sensor may comprise a sensor configured to sense a conveyor. As should now be appreciated, the sensor may have a variety of different forms and configurations for outputting signals representing data pertaining to the sensed information.

In some implementations, RF emitter 42 is carried by the facility occupant 40, such as where RF emitter 42 is incorporated as a badge worn by facility personnel. In some implementations, RF emitter 42 may be mounted otherwise attached to the facility occupant 40. In some implementations, the RF emitter 42 may be embedded into the facility occupant 40. For example, in some implementations, RF emitter 42 may be embedded within a pallet serving as the facility occupant 40.

Computing platform 30 comprises a computing device configured to determine coordinates of the facility occupant based upon triangulation of the signals from the matrix of RF mesh extenders 28. Computing platform 30 is communicatively coupled to at least one of mesh extenders 28 in a wired or wireless fashion so as to receive RF signals from each of mesh extenders 28. Computing platform 30 comprises processing unit 44 and memory 46.

Processing unit 44 is configured to follow instructions contained in memory 46, which comprises a non-transitory computer-readable medium. Such instructions direct processing unit 44 to triangulate the various signals from the various mesh extenders 28 to determine and output the location coordinates 50 for the facility occupant.

In the example illustrated, facility occupant 40 with the associated RF emitter 42 sends RF signals 52 to mesh extenders 28-4, 28-5, 28-7, 28-8 and 28-11. Although not illustrated, such RF signals may additionally be sent to other mesh extenders 28. In the example illustrated, mesh extender 20-4 forwards the received RF signal from emitter 42 two mesh extender 28-7. Mesh extender 20-7 forwards the RF signals received directly from RF emitter 42 and though signals received from mesh extender 20-4 two mesh extender 28-10. Likewise, mesh extender 28-5 forwards the RF signals received from RF emitter 42 two mesh extender 28-8. Mesh extender 20-8 forwards the RF signals received directly from RF emitter 42 and those received from mesh extender 28-5 to mesh extender 28-11. Mesh extender 28-11 forwards those RF signals received directly from RF emitter 42 and those RF signals received from mesh etc. 28-8 two mesh extender 28-10. Being in close proximity to computing platform 30, mesh extender 20-10 forwards all of the received RF signals to processing unit 44. As should be appreciated, the router path along which RF signals are relayed amongst one another and to computing platform 30 may vary depending upon the array of mesh extenders 28-4 and their locations, the availability of such mesh extenders 28 to receive our forward signals left for and some mesh centers may be busy with other signals or operations), or shortest or fastest route for the relaying of RF signals. In some implementations, mesh extenders 28 may be simultaneously receiving RF signals from multiple facility occupants 40 and associated RF emitters 42 within building 24 such that transmission and forwarding queues may result. In some implementations, computing platform 30 may receive RF signals from multiple different individual mesh extenders 28.

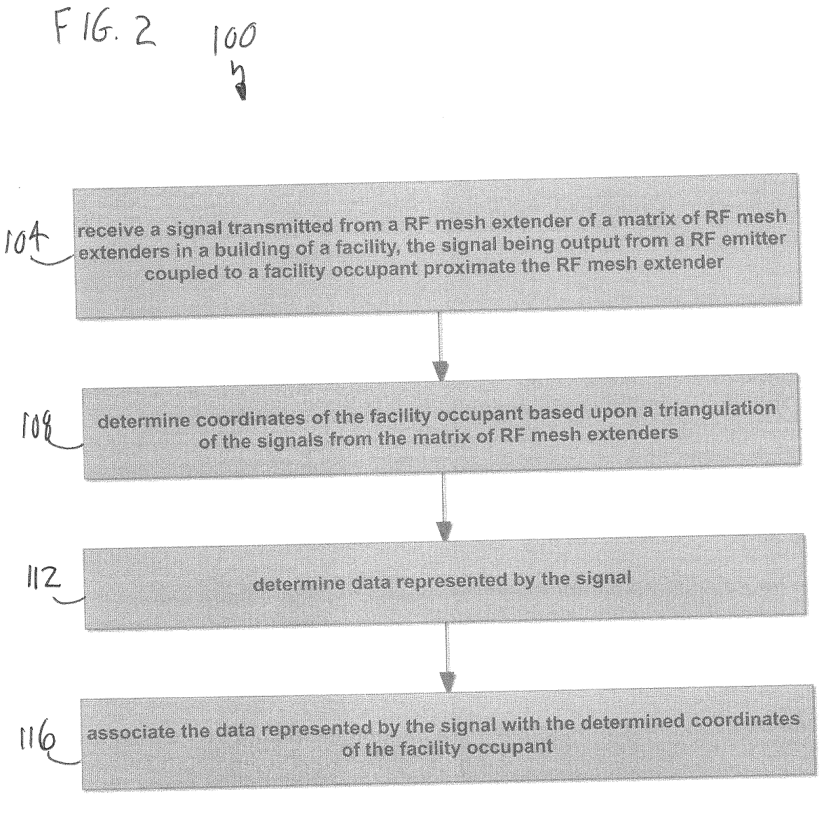

FIG. 2 is a flow diagram of an example industrial facility monitoring method 100. Method 100 may be carried out by a processing unit following instructions contained in a non-transitory computer-readable medium. Although method 100 is described in the context of being carried out by system 20, method 100 may likewise be carried out by other similar monitoring systems.

As indicated by block 104, a computing platform or processing unit receives a signal transmitted from aim RF mesh extender of a matrix of RF mesh extenders in a building of the facility. The signal is output from a RF emitter coupled to a facility occupant proximate the RE mesh extender. In the example illustrated in 1, processing unit 44 receives a signal transmitted from an RF mesh extender 28-10 of a matrix of RF mesh extenders 28 and a building 24 of the facility 22. The signal originates or is output from an RF emitter 42 associated with her coupled to a facility occupant 40 proximate the RF mesh extender 28-4.

As indicated by block 108, the coordinates of the facility occupant are determined based upon triangulation of the signals from the matrix of RF mesh extenders. In the example shown in FIG. 1, processing unit 44 determines accordance of the facility occupant 40 based upon a translation of signals received from mesh extenders 28-4, 28-5, 20-7, 28-8 and 28-11. The strength or timing of receipt of such RF signals may be used in such triangulation to establish the locational coordinates for emitter 42 and facility occupant 40. In some implementations, each mesh extender may be configured to add an identifier or tag to the signal received directly from emitter 42, the identifier tag identifying the original mesh extender 28 that receive the particular RF signal directly from the RF emitter 42. In some implementations, signals from a greater or fewer of such mesh extenders may be used to triangulate the locational coordinates of facility occupant 40.

As indicated by block 112 the data represented by the RF signal is determined. In the example illustrated, processing unit 44, following instructions contained in memory 46, translates the RF signals to determine the data/information represented by the signals. For example, the data represented by the signals may be an identification of facility personnel, and operational status of a manufacturing equipment or a material transport vehicle or device, an amount of inventory supported by the facility occupant 40 or the like. The data represented by the RF signals may indicate a level of electrical charge remaining in a battery, an amount of fuel remaining in a tank, the next scheduled time for maintenance or repair, or the like. The RF signals may contain or represent data as determined from a sensor or multiple sensors associated with the facility occupant 40.

As indicated by block 116, the data represented by the RF signal is associated with the determined coordinates of the facility occupant. In the example illustrated, processing unit 44, following the instruction contained in memory 46, associates or assigns the data represented by the signal to the determined coordinates for the facility occupant of the socially with the emitter 42 that output such signals. The data and its associated coordinates may be used to track or monitor the status of facility occupant 40 such as its movement, volume, weight, or the like. The data and is associated coordinates may be used as an input to a decision model used by processing unit 44 to output control signals or notifications.

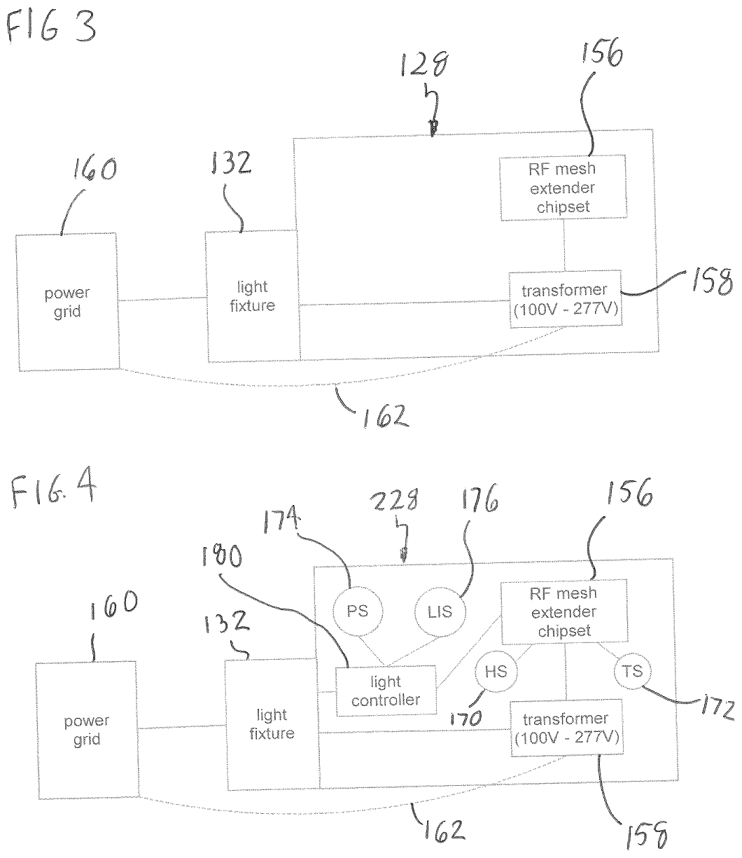

FIG. 3 is a diagram schematically illustrating an example RF mesh extender 128 which may be used for any of the mesh extenders 28 shown in FIG. 1. Mesh extender 128 comprises an RF mesh extender chipset 156 and a transformer 158. RF mesh extender chipset 156 carries out the receipt of RF signals and the relaying or forwarding of such RF signals. In some implementations, RF mesh extender chipset 156 may comprise a multiprotocol SOC chipset that is WIREPAS ENABLED, such as the product NRF 52832 commercially available from Nordic Semiconductor.

Transformer 158 comprises electrical circuitry configured to transform electrical power from a power grid 160 at any voltage from 100 votes to 277 V to a voltage for use by the RF mesh extender chipset 156. In one implementation, transformer 158 converts the receive voltage to a voltage of approximate 3 V for use by the RF mesh extender chipset 156. Transformer 158 facilitates use of extender 128 with a wide variety of facilities that utilize different voltage levels. In the example illustrated, mesh extenders 128 is configured to be directly affixed to a building structure in the form of light fixture 132. In such an implementation, transformer 158 may be directly wired to the electrical circuitry of the light fixture 130, drawing electrical power from the light fixture 130. As indicated by broken line 162, in other implementations, transformer 158 may be directly connected to the power grid 160 for receiving electrical power directly from the power grid 160. Because extender 128 receives power, directly or indirectly from the power grid 160, rather than relying upon battery power, RF mesh extender 128 may obtain and relay RF signals at a greater frequency, greater power level and for longer distances, enhancing the reliability of RF signal (and in some implementations data) communication.

FIG. 4 is a diagram schematically illustrating portions of an example RF mesh extender 228. Mesh extender 228 may be utilized in place of any or all of the mesh extenders 28 of system 20. Mesh extender 228 is similar to mesh extender 128 described above except that mesh extender 228 additionally comprises humidity sensor 170, temperature sensor 172, proximity sensor 174, light intensity sensor 176 and light controller 180. Those remaining components of RF mesh extender 228 which correspond to components of RF mesh extender 128 are numbered similarly.

Humidity sensor 170 comprises sensor to detect and output signals indicating the humidity of the environment surrounding the particular RF mesh extender 228. Temperature sensor 172 comprise a sensor to detect and output signals indicating the temperature of the environment surrounding the particular RF mesh extender 228. Such temperature and humidity signals are transmitted to the RF mesh extender chipset 156 which may forward such signals and data to the computing platform, such as platform 30 described above, for monitoring and managing a facility, such as facility 22. In some implementations, RF mesh extender 228 may omit one or both of humidity sensor 170 and temperature sensor 172.

Proximity sensor 174 comprise a device to sense the presence of a dynamic facility occupants, including those facility occupants which may not the carrying or associated with an RF emitter 42. In some implementations, proximity sensor 174 comprises a passive infrared sensor. In other implementations, proximity sensor 174 may have other configurations.

Light intensity sensor 176 comprises sensor to detect the intensity or lack thereof of ambient light proximate to the particular RF mesh extender 228. Signals from proximate sensor 174 and light intensity sensor 176 are transmitted to light controller 180.

Light controller 180 comprises a processing unit and associated non-transitory computer-readable medium containing instructions for outputting light fixture control signals. In some implementations, light controller 180 may be configured as an integrated circuit. In the example illustrated, light controller 180 automatically outputs control signals adjusting the operational light fixture 130 such as disconnecting the supply of power to light fixture 130, turning on the supply of power to light fixture 130 and/or adjusting the light intensity (dimming) a light fixture 130 based upon signals from proximity sensor 174 and light intensity sensor 176.

For example, upon proximity sensor 174 detecting the presence of a dynamic facility occupant, light controller 180 may turn on or increase a light intensity of light fixture 130. Alternatively, upon proximity sensor 174 not detecting a facility occupant, light controller 180 may output control signals dimming or turning off light fixture 130. Depending upon the intensity of ambient light during particular time of day, time a year or the like, as detected by light intensity sensor 176, light controller 180 may output control signals to adjust the light intensity of the light provided by light fixture 130. In some implementations, one or both of proximity sensor 174 and light intensity sensor 176 may be omitted, wherein light controller 180 may receive light fixture commands transmitted from computing platform 30 (shown in FIG. 1) via the matrix of mesh extenders 228. In some implementations, RF mesh extender 228 may omit each of sensors 174, 176 and light controller 180.

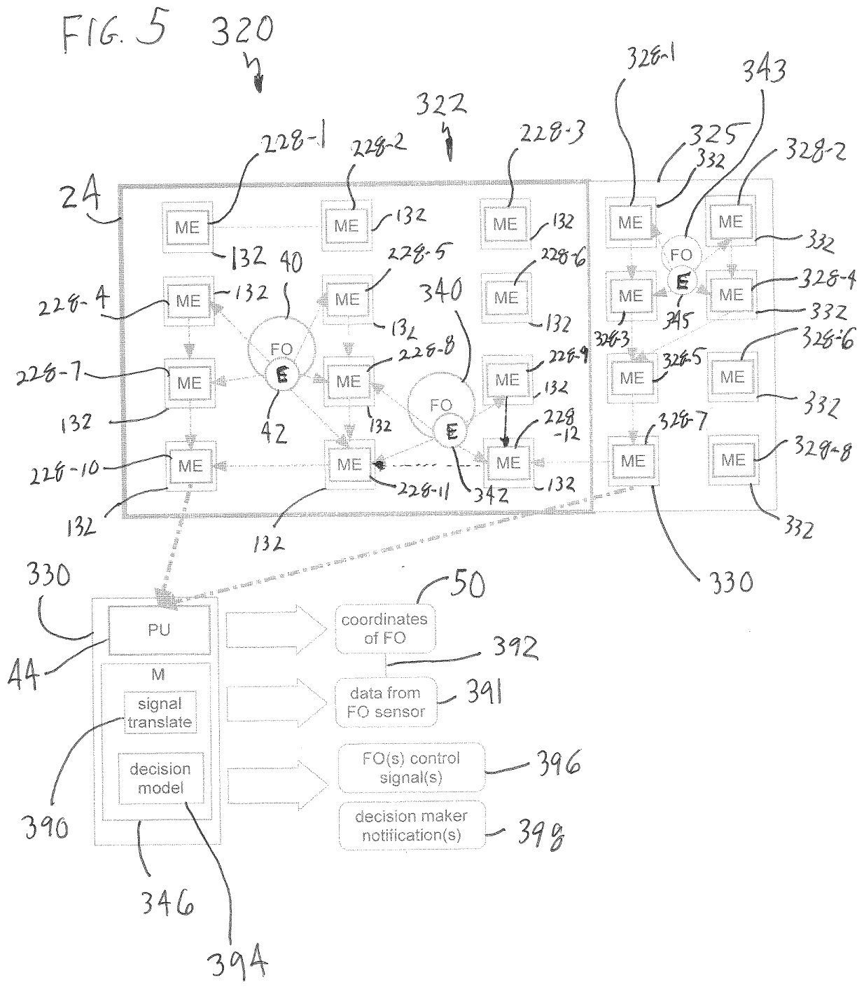

FIG. 5 is a diagram schematically illustrating portions of an example industrial facility monitoring system 320 for monitoring facility 322. Facility 322 includes building 24 and a region 325 external to building 24. Building 24 is described above. Region 325 comprises an area, such as a parking lot, loading/unloading area or the like external to the building 24. Region 325 may include a multitude of fixed structures 332, such as light fixtures, light poles or the like.

System 320 comprises a first matrix of radiofrequency mesh extenders 228-1, 228-2, 228-3, . . . 228-12 (collectively referred to as ash extenders 228), a second matrix of radiofrequency mesh extenders 328-1, 328-2, 328-3, . . . 328-8 (collectively referred to as mesh extenders 328), and a computing platform 330. Each of mesh extenders 228 and 328 may be similar to the mesh extender 228 shown in FIG. 4. Mesh extenders 228 are affixed to internal overhead lighting fixtures within building 24. Mesh extenders 328 are affixed to external lighting fixtures 332 or light poles external to building 24. Although the matrix of mesh extenders 328 is illustrated as a 2×4 array, in other implementations, system 320 may include a matrix of mesh extenders 328 having other arrangements, numbers of mesh extenders or layouts. For example, different portions of the external region 325 may include different densities of RF mesh extenders 328.

Computing platform 330 comprises processing unit 44 and memory 346. Processing unit 44 is described above. Computing platform 30 is communicatively coupled to at least one of mesh extenders 228, 328 in a wired or wireless fashion so as to receive RF signals from each of mesh extenders 28. Processing unit 44 comprises electrical circuitry configured to carry out computing functions according to instructions contained in memory 346.

Memory 346 comprises a non-transitory computerized readable medium containing instructions for directing the operation of processing unit 44. As with memory 46, memory 346 comprises instructions for directing processing unit 44 to determine the location accordance of facility occupants based upon the RF signals received from the matrix of mesh extenders 228, 328. As discussed above, processing unit 44 may carry out triangulation based upon input such as the strength of the RF signals, the timing of the RF signals or the like. Patient such triangulation, processing unit 44 may determine the coordinates 50 of each of facility occupants.

In the example illustrated, building 24 is illustrated as including two example facility occupants 40 and 340 within building 24 and a third facility occupant 343 external to building 24, within region 325. Facility occupant 340 is associated with or is coupled to and RF emitter 342. Facility occupant 343 is associated with our coupled to and RF emitter 345. In the example illustrated, each of emitter's 42, 342 and 345 emits RF signals which represent data or information pertaining to the associated facility occupant and/or its surroundings.

In the example illustrated, system 320 determines the locational coordinates of facility occupant 40 as described above with respect to FIG. 1. System 320 determines the location coordinate of facility occupant 340 by triangulating the RF signals emitted by RE emitter 342 and received by RF mesh extenders 228-8, 228-9, 228-11 and 228-12. In the example illustrated, the RF signals received by mesh extender 228-8 directly from emitter 342 are relayed to computing platform 330 via mesh extender 228-11 and mesh extender 228-10. The RF signal by mesh extender 228-9 directly from emitter 342 are relayed to computing platform 330 using mesh extender 220-12, mesh extender 228-11 and mesh extender 228-10. The RF received directly from emitter 342 by mesh extender 220-12 are relayed to computing platform 330 by mesh extender 228-11 and mesh extender 228-10. The RF signals received directly from emitter 342 by mesh extender 228-11 are relayed to computing platform 330 by mesh extender 228-10. In other implementations, the routing or path of relaying RF signal to computing platform 330 may be varied to achieve the shortest, more reliable or fastest relay or forwarding time for such RF signals.

In addition to including coordinate location determination instructions for determining the location coordinates of each facility occupant within building 24 and within region 325, memory 346 further comprises signal translate instructions 390. Instructions 390 direct processing unit 44 to translate the multiple different signal formats from the multiple different RF emitter's 42, 342 and 345 into the particular information or data represented by such RF signals. For example, emitter 42 may emit a first RF signal having a first format representing data sensed by an associated sensor. Emitter 342 may emit a second different RF signal having a second format, different than the first format, and representing a second set of data sensed by an associated sensor. Emitter 345 may emit a third different RF signal having a third format, different than the first format and the second format, and representing a third set of data represented by an associated sensor all or otherwise generated. Processing unit 44 translates or reads such different RF signals and determines the associated data following instructions of signal translate instructions 390. In some implementations, signal translate instructions 390 include various lookup tables or indices for different RF signal formats, providing a conversion from each individual distinct RF signal format to the meaning of the signals.

The determined data 391, translated from the RF signal following instructions 390, is associated or linked with the determined particular coordinates 54 the particular facility occupant 40, 340, 343 as indicated by line 392. This linked data may then be used by computing platform 330 for further decision or analysis.

As shown by FIG. 5, memory 346 may further comprise a decision model 394. Decision model 394 may be in the form of an algorithm, a sets of criteria, or the like. The decision model 394 may further comprise instructions for directing processing unit 44 to output control signals 396 or occasions 398 using the link data/coordinates as inputs to the decision model 394. Signals indicating the sensed humidity (humidity sensor 170) or temperature of from temperature sensor 172) may additionally be used as inputs to the decision model 394.

In some implementations, the decision model 394 may use the data 391 and associated coordinates 50 from each of multiple the occupants, in combination, to determine and generate control signals 396 and/or notifications 398. For example, RF signal to manufacturing equipment may indicate a current consumption of materials at a first rate. RF signals from a bitter tank may indicate a current supply level of the materials available for consumption by the piece of manufacturing equipment. The decision model 394 may direct processing and 44 to compare such data against a predefined threshold. Satisfaction of the predefined threshold may result in processing unit 44 outputting control signals 396 to the piece of manufacturing equipment to adjust the rate at which the material is consumed. Alternatively, satisfaction the predefined threshold may result in processing unit 44 outputting a notification to a decision-maker to order or otherwise acquire the material to replenish the inventory or supply of material.

The control signals 396 may be transmitted to the facility occupant from which the data that served as an input was received or may be transmitted to other facility occupants in building 24 or in region 325. The notifications 398 may be transmitted to those decision-makers associated with facility 322. Such decision-makers a be remote from facility 322, wherein such notifications are transmitted to a cloud-based system. In some implementations, computing platform 330 comprises a cloud-based remote platform which receives the RF signals from the local facility 322.

Although the present disclosure has been described with reference to example implementations, workers skilled in the art will recognize that changes may be made in form and detail without departing from the disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

1. An industrial facility monitoring system comprising:
a matrix of radiofrequency (RF) mesh extenders fixed to building structures of a facility and located throughout an interior of the facility, each of the mesh extenders to receive signals from RF emitters coupled to facility occupants; and
a processing unit to receive signals from the RF mesh extenders and to determine coordinates of a facility occupant based upon a triangulation of the signals from the matrix of RF mesh extenders.

2. The industrial facility monitoring system of claim 1, wherein the matrix of RF mesh extenders comprises a mesh extender mounted to a light fixture.

3. The industrial facility monitoring system of claim 2, wherein the light fixture receives electrical power from a power grid and wherein the RF mesh extender is hardwired to the power grid to receive power from the power grid.

4. The industrial facility monitoring system of claim 1, wherein the RF mesh extender comprises:
an RF mesh extender chipset; and
a transformer configured to receive electrical power from the power grid at any voltage from 100 votes to 277 V and to transform the electrical power to a voltage for use by the RF mesh extender chipset.

5. The industrial facility monitoring system of claim 3, wherein the RF mesh extender is wired to receive power from the light fixture.

6. The industrial facility monitoring system of claim 5, wherein the mesh extender is further configured to control operation of the light fixture.

7. The industrial facility monitoring system of claim 6, wherein the mesh extender comprises a proximity RF emitter and is configured to control operation of the light fixture based upon signals from the proximity RF emitter.

8. The industrial facility monitoring system of claim 7, wherein the mesh extender comprises a light intensity RF emitter and is configured to control operation of the light fixture based upon signals from the light intensity RF emitter.

9. The industrial facility monitoring system of claim 3, wherein the RF mesh extender comprises at least one of a temperature RF emitter and a humidity RF emitter.

10. The industrial facility monitoring system of claim 1, wherein the facility occupant comprises inventory.

11. The industrial facility monitoring system of claim 1, wherein the facility occupant comprises a pallet supporting inventory.

12. The industrial facility monitoring system of claim 11 further comprising a RF emitter, the RF emitter being embedded in the pallet.

13. The industrial facility monitoring system of claim 1, wherein the facility occupant comprises a forklift.

14. The industrial facility monitoring system of claim 1, wherein the facility occupant comprises a piece of manufacturing equipment.

15. The industrial facility monitoring system of claim 1, when the facility occupant comprises facility personnel.

16. The industrial facility monitoring system of claim 1 further comprising a RF emitter for coupling to a reel, the RF emitter detecting an amount of inventory wound about the reel.

17. The industrial facility monitoring system of claim 1 further comprising a second matrix of RF mesh extenders fixed to fixed structures external to the building of the facility and configured to receive signals from RF emitters coupled to the facility occupants when external to the facility, wherein the processing unit is to determine coordinates of the facility occupants external to the facility based upon a triangulation of signals from the second matrix of mesh extenders.

18. The industrial facility monitoring system of claim 17, wherein the RF mesh extenders of the second matrix are mounted to light fixtures external to the building of the facility.

19. The industrial facility monitoring system of claim 18, wherein the light fixtures receive electrical power from a power grid and wherein the RF mesh extenders of the second matrix are hardwired to the power grid to receive power from the power grid.

20. The industrial facility monitoring system of claim 19, wherein the RF mesh extenders of the second matrix comprises a RF mesh extender of the second matrix that is wired to receive power from the light fixture.

21-42. (canceled)
